(19) United States
(12) Patent Application Publication
(10) Pub. No.: US 2006/0087535 A1
(43) Pub. Date: Apr. 27, 2006

(54) Inkjet print head with a high efficiency heater and method of fabricating the same

(76) Inventors: Sung-joon Park, Suwon-si (KR); Young-ung Ha, Suwon-si (KR); Eun-bong Han, Suwon-si (KR); Jae-sik Min, Suwon-si (KR)

Correspondence Address: STANZIONE & KIM, LLP, 919 18TH STREET, N.W., SUITE 440, WASHINGTON, DC, 20006, US

(21) Appl. No.: 11/248,160

(22) Filed: Oct. 13, 2005

(30) Foreign Application Priority Data
Oct. 26, 2004 (KR) 2004-85967

(51) Int. Cl. B41J 2/05

(52) U.S. Cl. 347/59

(57) ABSTRACT

A method of fabricating a high efficiency inkjet print head includes forming an oxide film on a surface of a substrate, sequentially forming and patterning a heater layer and a wiring layer on the oxide film, forming a passivation layer on the heater layer and the wiring layer and patterning the passivation layer so that a heater is exposed, etching the substrate to form restrictors at both sides of the heater, forming a chamber layer on the passivation layer, forming a sacrificial layer on the chamber layer and polishing the sacrificial layer, forming a nozzle layer on the chamber layer, forming an ink-feed hole at a bottom surface of the substrate, and removing the sacrificial layer. The inkjet print head is capable of reducing energy consumption by fabricating a heater having high efficiency, and capable of maintaining good heating characteristics since an original temperature of the inkjet print head is rapidly recovered after the heater is instantly heated and electric current is not supplied. In addition, since the heater is mounted on the substrate, the inkjet print head can maintain structural integrity, and since the heater is formed in a planar shape without bent portions, the heater can be formed to a uniform thickness.

### CROSS-REFERENCE TO RELATED APPLICATIONS

This application claims the benefit of Korean Patent Application No. 2004-85967, filed on Oct. 26, 2004, the disclosure of which is hereby incorporated herein by reference in its entirety.

### BACKGROUND OF THE INVENTION

1. Field of the Invention

The present general inventive concept relates to a high efficiency inkjet print head and a method of fabricating the same, and more particularly, to an inkjet print head to efficiently eject ink stored in a cartridge of an inkjet printer in a fine droplet shape and a method of fabricating the same.

2. Description of the Related Art

An inkjet printer is a type of image forming apparatus to obtain a desired shape of a printed subject matter (e.g., image, text, etc.) by ejecting ink stored in a cartridge to a surface of a printing medium through a print head in a fine droplet shape. The print head may be generally classified as either a thermal driving type having a heater to eject the ink droplets using pressure of bubbles generated in the ink due to heat generated by the heater, or a piezoelectric driving type to eject the ink droplets using pressure applied to the ink due to mechanical deformation of a piezoelectric material.

Referring to FIG. 1, a conventional thermal driving type print head is illustrated. The print head includes an ink-feed hole 12 formed in a substrate 10 to supply ink from an ink cartridge to the print head, a chamber layer 14 formed on a top surface of the substrate 10 to define an ink chamber 18 for temporarily storing the ink, and a restrictor 16 for supplying the ink received from the ink-feed hole 12 into the print head. A nozzle 20 is formed at an upper portion of the chamber layer 14, and a heater 22 is formed under the nozzle 20. In order to prevent the heater 22 from being damaged due to a reaction with the ink, a passivation layer 24 is formed on a top surface of the heater 22. In addition, the heater 22 is connected to a pad 26, and the pad 26 is connected to a main body of the inkjet printer through a flexible printed circuit board (PCB) (not shown).

When a pulse current is applied to the heater 22, the heater 22 is instantly heated to generate bubbles 30 from the top surface of the heater 22, and ink droplets 28 are discharged through the nozzle 20 due to an increase in pressure provided by the bubbles 30. However, the heater 22 illustrated in FIG. 1 performs heat transfer through only the top surface, therefore heat generated from a bottom surface of the heater 22 only increases a temperature of the print head and does not aid in heating the ink. This reduces heat transfer efficiency of the heater 22. Moreover, the passivation layer 24 located on the top surface of the heater 22 further decreases the heat transfer efficiency.

In an attempt to solve the problem described above, FIG. 2 illustrates another conventional print head including a chamber layer 54 formed on a substrate 50 having an ink-feed hole 52 and a restrictor 56, and a heater 58 for heating ink introduced through the restrictor 56. The heater 58 is located at a center of an ink chamber 57, thereby heating the ink using both surfaces thereof. Since the heating is performed using both surfaces of the heater 58, ink droplets can be ejected using a power less than a power used in other conventional print heads.

However, when the power is not applied to the heater 58 after ejecting the ink droplets, bubbles shrink to apply a cavitation force on the surface of the heater 58. As a result, the heater 58 may be deformed and damaged. However, since generation or extinction of the bubbles occurs in opposite directions with respect to both surfaces of the heater 58, the cavitation force is offset to remarkably reduce impact on the heater 58, thereby extending lifetime of the heater 58.

However, since the heater 58 is shaped at a right angle structure rather than a planar structure like the other conventional print heads, the heater 58 may have an irregularly shaped thickness formed at a bent portion. That is, heaters for print heads are typically made by depositing a heater material layer using a sputtering or CVD method, and then patterning the heater material. Therefore, as illustrated in FIG. 2, it may be difficult to form the heater 58 to have a desired thickness at the bent portion of the right angle structure. That is, since the thickness of the heater material layer becomes irregular around the bent portion, a probability of an electrical short circuit due to concentration of current density increases when the bent portion has a thin thickness. Therefore, the heater 58 has disadvantages in productivity as well as a difficulty of precisely adjusting a heating value of the heater 58 during operation.

In addition, since a thin layer used as the heater material and is typically formed on a sacrificial layer made of photoresist, a process temperature required to form the thin layer is limited due to characteristics of the photoresist used as the sacrificial layer. As a result, it is difficult to form a thin layer of high quality, and materials available to form the heater 58 material are also limited. In addition, while the cavitation force generated at both surfaces of the heater 58 should be precisely equal, it is not actually equal. Therefore, the heater 58 is still affected by the cavitation force. Furthermore, the heater 58 has a weak structure since it is suspended in the ink chamber 18.

### SUMMARY OF THE INVENTION

The present general inventive concept provides an inkjet print head with a high efficiency heater capable of minimizing impact of a cavitation force as well as maintaining high efficiency characteristics.

The present general inventive concept also provides a method of fabricating the inkjet print head.

Additional aspects and advantages of the present general inventive concept will be set forth in part in the description which follows, and in part, will be obvious from the description, or may be learned by practice of the general inventive concept.

The foregoing and/or other aspects and advantages of the present general inventive concept may be achieved by providing a method of fabricating an inkjet print head with a high efficiency heater, the method including forming an oxide film on a surface of a substrate, forming and patterning a heater layer and a wiring layer on the oxide film, forming a passivation layer on the heater layer and the wiring layer and patterning the passivation layer so that a heater is exposed, etching the substrate to form restrictors at both sides of the heater, forming a chamber layer on the passivation layer, forming a sacrificial layer on the chamber layer and polishing the sacrificial layer, forming a nozzle layer on the chamber layer, forming an ink-feed hole at a bottom surface of the substrate, and removing the sacrificial layer.

The heater is disposed on the substrate to remove the passivation layer located at a surface of the heater, thereby obtaining a high thermal efficiency. In addition, since the heater is formed on the substrate rather than on a sacrificial layer, the heater formed by depositing a thin layer of heater material can using a process temperature that is sufficiently high.

The heater may be patterned to include a slit. That is, the heater may be divided into two heat-generating parts by the slit disposed therebetween, and bubbles generated from each of the heat-generating parts may be gathered into one large bubble causing ink to be ejected through the nozzle. As a result, cavitation force that results from disappearance of the bubbles may impact the slit rather than directly impacting the surface of the heater, thereby extending lifespan a of the heater.

The slit may have a width of 1˜3 micrometers (μm).

In addition, the heater may include one of Ta, TaN, Ta—Al, TiN, and Pt, and the heater may be formed to a thickness of 1000˜5000 Angstroms (Å).

The wiring layer may include one of Al or Au, and may be formed to a thickness of 5000˜10000 Å.

The passivation layer may include one of SiOx, SiNx, SiC, and DLC.

In addition, in order to increase integration of the inkjet print head, the restrictor is formed in a direction perpendicular to a direction in which the heater layer extends.

The chamber layer may be formed by forming and patterning a photo epoxy layer on the passivation layer.

In addition, the sacrificial layer may include one of polyimid, rubber-based photoresist, and patternable Si.

The nozzle may be formed to have an inclined angle of 5˜10°.

The foregoing and/or other aspects and advantages of the present general inventive concept may also be achieved by providing an inkjet print head with a high efficiency heater, the inkjet print head including an ink-feed hole formed at a bottom surface of a substrate, a restrictor formed on the ink-feed hole to be in fluid communication with a top surface of the substrate, a chamber layer formed on the substrate and having an ink chamber and a nozzle, and a wiring layer and a heater layer formed between the chamber layer and the substrate, wherein a portion of the heater layer located in the ink chamber is in direct contact with ink filled in the ink chamber, and has a slit formed at a center of the portion.

The slit may have a width of 1˜3 μm, and the restrictor extends in a direction perpendicular to the top surface of the substrate and perpendicular to a direction in which the heater layer extends.

In addition, the restrictor may be spaced apart from the heater in the ink chamber by a distance less than or equal to 3 μm.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view illustrating a conventional inkjet print head;

FIG. 2 is a schematic cross-sectional view illustrating another conventional inkjet print head;

FIG. 3 is a cross-sectional view illustrating an inkjet print head with a high efficiency heater according to an embodiment of the present general inventive concept;

FIG. 4 is a plan view illustrating a heater layer and a wiring layer around an ink chamber in the inkjet print head of FIG. 3;

FIGS. 5A to 5C are cross-sectional views illustrating conventional inkjet print heads compared with the inkjet print head of FIG. 3; and

FIGS. 6A to 6H are cross-sectional views illustrating a method of fabricating the inkjet print head of FIG. 3 according to an embodiment of the present general inventive concept.

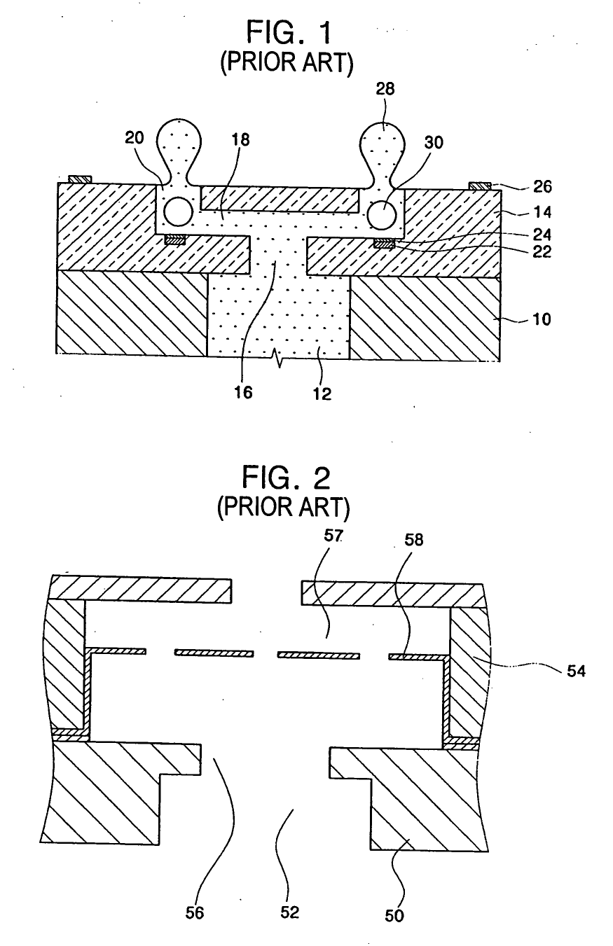

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

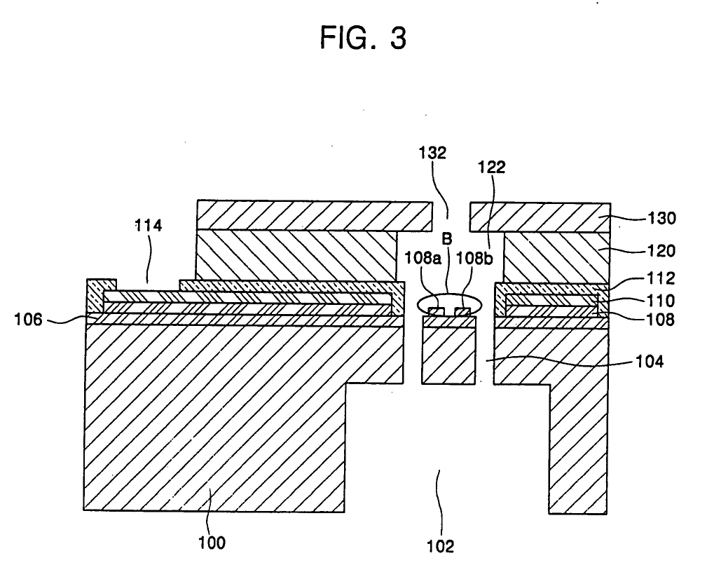

Referring to FIG. 3, an embodiment of an inkjet print head in accordance with the present general inventive concept includes a substrate 100 made of a material, e.g., silicon, and an ink-feed hole 102 formed at a bottom surface thereof to receive ink supplied from an ink cartridge (not shown). The ink-feed hole 102 may be formed along the entire inkjet print head, and a restrictor 104 to supply the ink introduced into the ink-feed hole 102 to an ink chamber 122 corresponding to the ink-feed hole 102 is formed therebetween. As illustrated in FIG. 3, the restrictor 104 may have two parts (i.e., restrictors) that are disposed in a symmetrical manner about heaters 108a and 108b, and extend in the same direction as ink droplets discharged through a nozzle 132, which will be described below.

That is, since a horizontal area occupied by the restrictor 104 is defined by an area inside of the ink chamber 122, more nozzles can be disposed in the same amount of area to increase the degree of integration of the nozzle 132. An oxide film 106 may be formed on a top surface of the substrate 100. The oxide film 106 insulates a heater layer 108 from the substrate 100 and prevents the ink from flowing between the heater layer 108 and the substrate 100.

The heater layer 108 is formed on the oxide film 106. The heater layer 108 is formed as a thin layer having a thickness of 1000 to 5000 Angstroms (Å) and made of a material selected from a group including Ta, TaN, Ta—Al, TiN, and Pt using a deposition method. The thin layer is then patterned to form the heaters 108a and 108b of the heater layer 108 located in the ink chamber 122 to be disposed parallel to each other and having a slit interposed therebetween.

The slit may have a width of 1 to 3 micrometers (μm), and the heaters 108a and 108b may be disposed to be spaced apart from the restrictor 104 by a distance less than or equal to 3 μm. As a result, as illustrated in FIG. 3, two ink bubbles formed by each of the heaters 108a and 108b are gathered into one large bubble B to eject ink through the nozzle 132. A cavitation force generated as a result of disappearance of the large bubble B is applied to the slit located between the two heaters 108a and 108b instead of on the heaters 108a and 108b themselves. Therefore, a lifespan of the heaters 108a and 108b may be extended, since it is possible to prevent the cavitation force from being applied directly to surfaces of the heaters 108a and 108b.

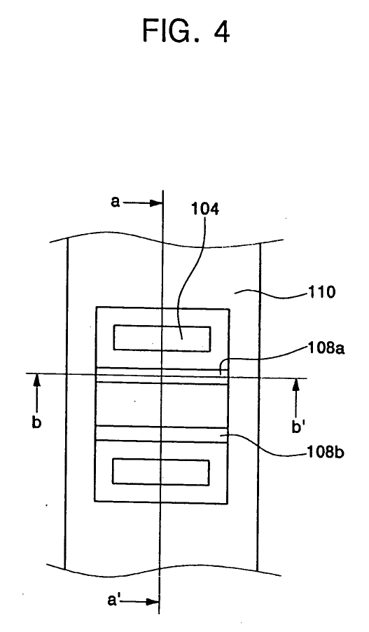

A wiring layer 110 is formed on the heater layer 108. FIG. 4 illustrates an arrangement of the heater layer 108 and the wiring layer 110. That is, FIG. 3 is a cross-sectional view taken along the line a-a′ in FIG. 4. The heaters 108a and 108b are exposed in the ink chamber 122, but the wiring layer 110 is not exposed. The heaters 108a and 108b are in contact with the wiring layer 110 at sides of the ink chamber 122, therefore an electric current may be applied to each of the heaters 108a and 108b. The wiring layer 110 may be formed of Al or Au, and may have a thickness of 5000 to 10000 Å.

The wiring layer 110 extends around inner walls of the ink chamber 122 that are both parallel (i.e., a longitudinal direction along a line b-b′ of FIG. 4) and perpendicular (i.e., a latitudinal direction along a line a-a′ of FIG. 4) to a direction in which the restrictor 104 extends. The wiring layer 110 extends from inner walls of the ink chamber 122 that are perpendicular to the direction in which the restrictor 104 extends to contact the heaters 108a and 108b.

It should be understood that the heaters 108a and 108b of the present general inventive concept are not be limited to the shape illustrated in FIG. 4, and the heaters 108a and 108b may have both ends connected to each other and a slit formed only at a center portion.

A passivation layer 112 may be formed on the wiring layer 110. The passivation layer 112 is formed to prevent the wiring layer 110 from being corroded by the ink by blocking the ink from coming in contact with the wiring layer 110. The passivation layer 112 may be a thin layer formed of a material such as SiOx, SiNx, SiC, and DLC having an excellent chemical resistance. The passivation layer 112 covers top and side surfaces of the wiring layer 110, and is not formed on top surfaces of the heaters 108a and 108b located in the ink chamber 122. As a result, since the heaters 108a and 108b are in direct contact with the ink, effective heat transfer becomes possible, thereby increasing thermal efficiency.

A pad 114 is formed at a portion of the wiring layer 110 located at an exterior of the ink chamber 122 by removing a portion of the passivation 112 layer where the wiring layer 110 is to be connected to a conductive trace (not shown) of a flexible printed circuit board (PCB).

A photo epoxy layer is formed on the passivation layer 112 as a chamber layer 120. The chamber layer 120 is formed by patterning the photo epoxy layer using a photoresist method so that the ink chamber 122 is defined by the chamber layer 120. A nozzle layer 130 is formed on the chamber layer 120, and a nozzle 132 to eject the ink droplets to the exterior is formed in the nozzle layer 130 located at a position corresponding to a center of the ink chamber 122.

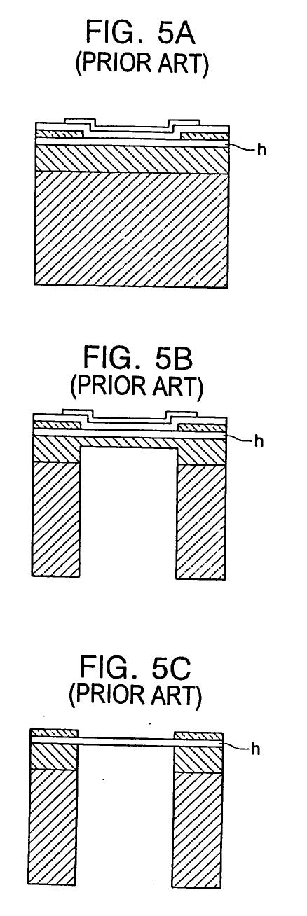

Table 1 represents test results for the inkjet print head of FIG. 3 compared to various types of conventional inkjet print heads illustrated in FIGS. 5A to 5C. A in Table 1 designates an inkjet print head illustrated in FIG. 5A, which heats the ink using a top surface of the heater h having a passivation layer on the heating surface. B in Table 1 designates an inkjet print head illustrated in FIG. 5B, which heats the ink using both surfaces of the heater h having passivation layers formed on each of the surfaces. C in table 1 designates an inkjet print head illustrated in FIG. 5C, which heats the ink using both surfaces of the heater h without a passivation layer formed thereon. D in Table 1 designates the inkjet print head of FIG. 3.

TABLE 1

| | | Time required to increase | | |
|---|---|---|---|---|
| | Input | heating surface | Input | Temperature after |
| | Voltage | temperature up to 300° C. | Energy | 100 μs is lapsed |
| A | 7.58 | 1.15 | 2294 | 34.6 |
| B | 7.58 | 1.34 | 2673 | 73.3 |
| C | 7.58 | 0.18 | 359 | 31.2 |
| D | 7.58 | 0.17 | 339 | 26.5 |

As described in Table 1, when the same input voltage was applied to heaters in inkjet print heads A to D, the temperature of the inkjet print head of FIG. 3 (i.e., inkjet print head D) was increased to 300° C. in the shortest period of time, and energy consumption during this process was also smallest. In addition, the inkjet print head D had the lowest temperature after a certain time elapsed, and its radiation performance was also excellent.

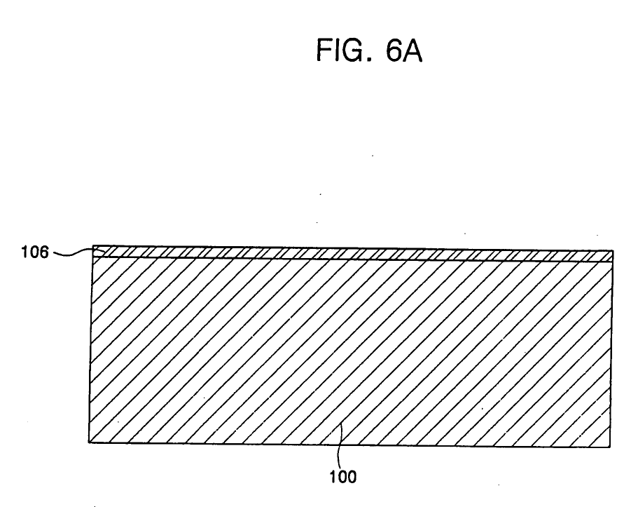

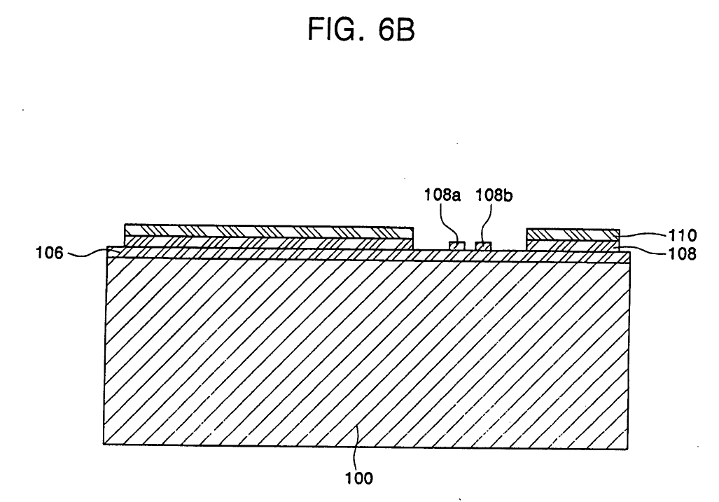

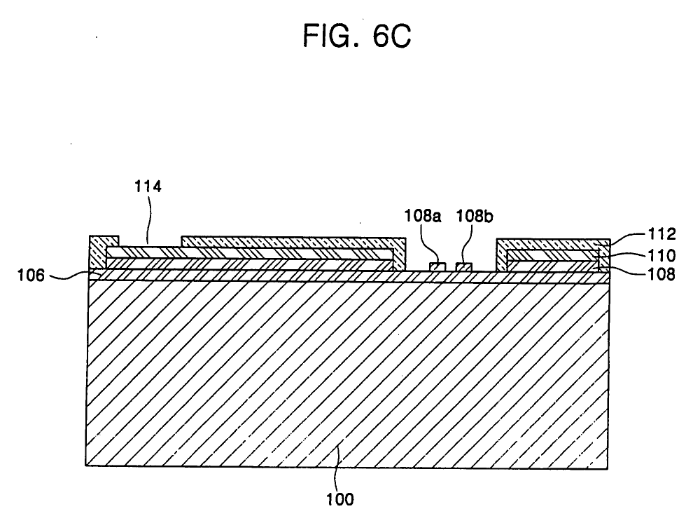

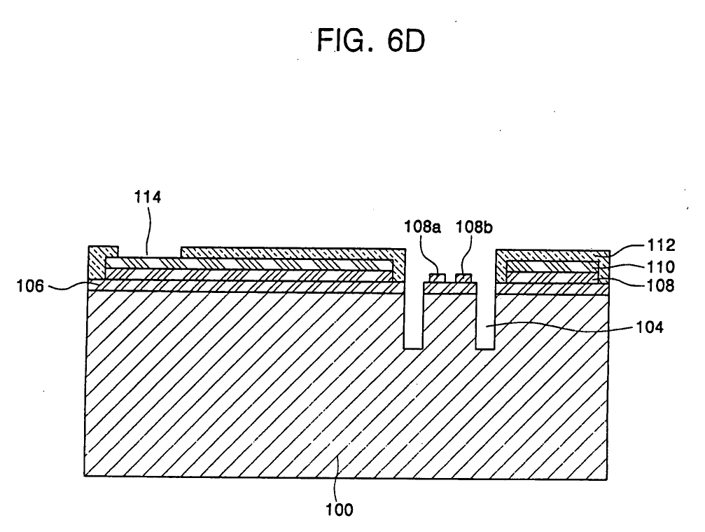

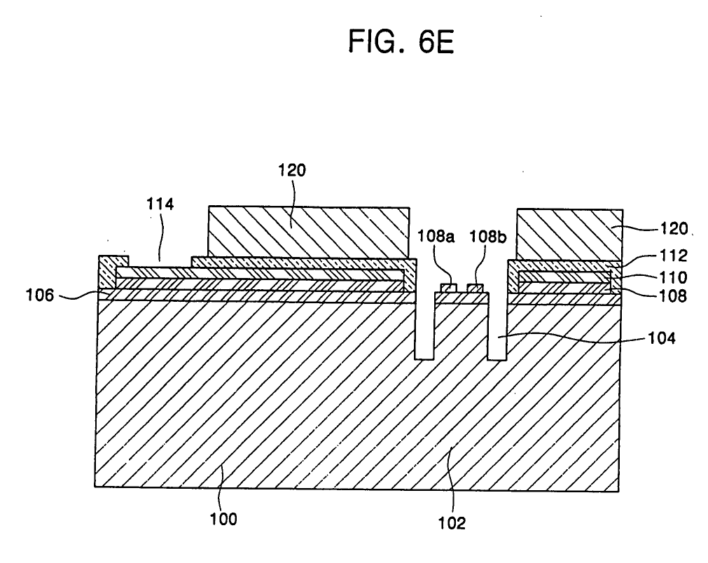

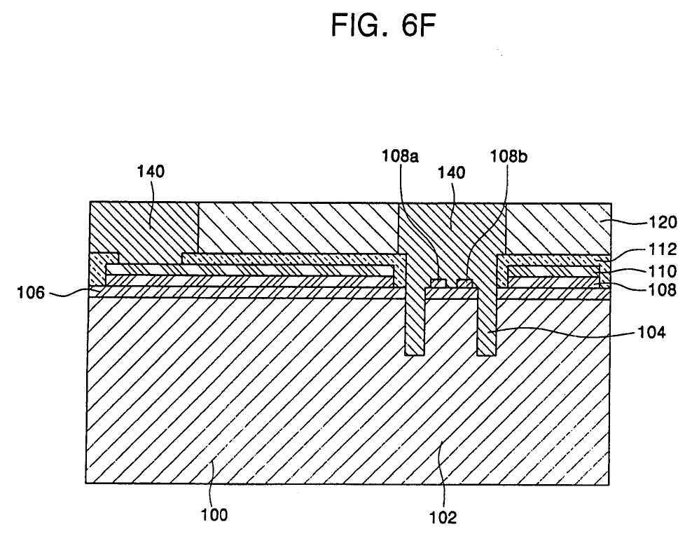

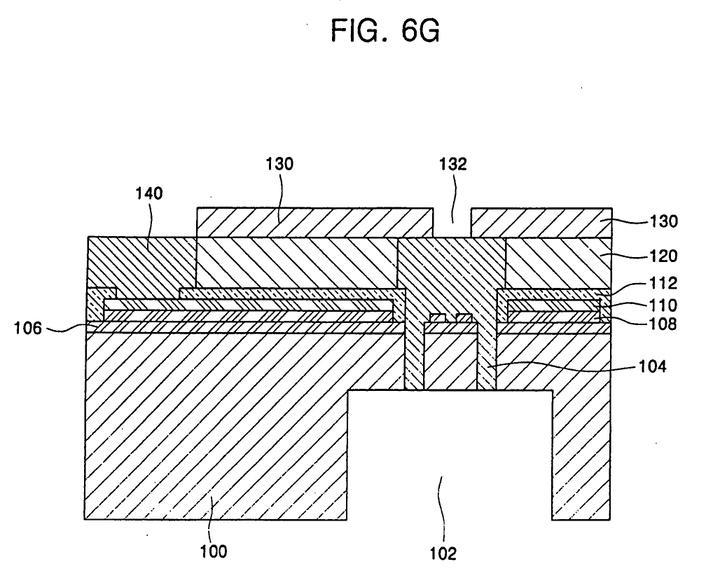

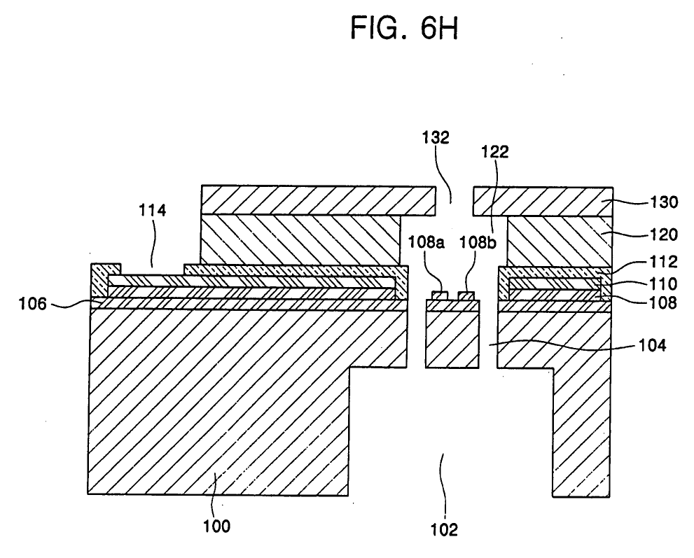

Hereinafter, a method of fabricating the inkjet print head of FIG. 3 will be described with reference to FIGS. 6A to 6H.

First, as illustrated in FIG. 6A, an oxide film 106 is formed on a substrate 100 made of a silicon wafer. A heater layer 108 and a wiring layer 110 are then sequentially deposited on the oxide film 106 and patterned to be machined into the shape illustrated in FIG. 6B. Accordingly, heaters 108a and 108b are formed. In this state, a passivation layer 112 is then formed on the heater layer 108 and the wiring layer 110. As illustrated in FIG. 6C, a portion of the passivation layer 112 is removed from top surfaces of the heaters 108a and 108b where an ink chamber 122 is to be located, and a portion of the passivation layer 112 is also removed from a top surface of the wiring layer 110 where a pad 114 is to be located.

As illustrated in FIG. 6D, once the removal of the portions of the passivation layer 112 from the top surfaces of heaters 108a and 108 and the pad 114 is completed, a restrictor 104 having two parts is formed on both side surfaces of the heaters 108a and 108b by an etching method. As illustrated in FIG. 6E, the passivation layer 112 is then coated with photo epoxy and etched to form a chamber layer 120. FIG. 6E also illustrates a region where an ink feed hole 102 is to be formed. As illustrated in FIG. 6F, a sacrificial layer 140 is then formed of one of a polyimid, rubber-based photoresist, patternable silicon, or the like. The sacrificial layer 140 is planarized until a top surface of the chamber layer 120 is exposed, using a chemical mechanical polishing (CMP) method (see FIG. 6F).

Once the planarization process is completed, a nozzle layer 130 is formed on a top surface of the chamber layer 120 and a top surface of the sacrificial layer 140 using the same material used for the chamber layer 120. As illustrated in FIG. 6G, the nozzle layer 130 is then patterned to form a nozzle 132. The nozzle may be formed to have wall surfaces with an angle of 5˜10° using focus of equipment and additives. Also as illustrated in FIG. 6G, once formation of the nozzle 132 is completed, the ink-feed hole 102 is formed by etching the a bottom surface of the substrate 100. As illustrated in FIG. 6H, the sacrificial layer 140 is then removed to complete fabrication of the inkjet print head.

As can be seen from the foregoing, the inkjet print head of the present general inventive concept is capable of reducing energy consumption by fabricating a heater having high efficiency in comparison with the conventional inkjet print heads, and maintaining good heating characteristics since an original temperature of the head is rapidly recovered after the heater is instantly heated and electric current is not supplied. In addition, since the heater is mounted on the substrate, the head can maintain structural integrity, and since the heater is formed in a planar shape without bent portions, the heater can be formed to a uniform thickness.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of fabricating an inkjet print head with a high efficiency heater, the method comprising:
forming an oxide film on a surface of a substrate;
forming and patterning a heater layer and a wiring layer on the oxide film;
forming a passivation layer on the heater layer and the wiring layer and patterning the passivation layer so that a heater is exposed;
etching the substrate to form restrictors at both sides of the heater;
forming a chamber layer on the passivation layer;
forming a sacrificial layer on the chamber layer and polishing the sacrificial layer;
forming a nozzle layer on the chamber layer;
forming an ink-feed hole at a bottom surface of the substrate; and
removing the sacrificial layer to form an ink chamber.

2. The method according to claim 1, wherein the heater is patterned to have a slit.

3. The method according to claim 2, wherein the slit has a width of 1˜3 μm.

4. The method according to claim 1, wherein the heater comprises a material selected from a group including Ta, TaN, Ta—Al, TiN, and Pt.

5. The method according to claim 4, wherein the heater is formed to a thickness of 1000˜5000 Å.

6. The method according to claim 1, wherein the wiring layer comprises any one of aluminum (Al) and gold (Au).

7. The method according to claim 6, wherein the wiring layer is formed to a thickness of 5000˜10000 Å.

8. The method according to claim 1, wherein the passivation layer comprises one of SiOx, SiNx, SiC, and DLC.

9. The method according to claim 1, wherein the restrictors are formed in a direction perpendicular to a direction in which the heater layer extends.

10. The method according to claim 1, wherein the chamber layer is formed by coating the passivation layer with photo epoxy.

11. The method according to claim 1, wherein the sacrificial layer comprises one of polyimid, rubber-based photoresist, and patternable Si.

12. The method according to claim 1, wherein the nozzle layer comprises a nozzle formed to have an inclined angle of 5˜10°.

13. A method of fabricating an inkjet print head, the method comprising:
providing a substrate having an ink feed hole extending therethrough;
forming an ink flow structure on the substrate to define an ink chamber and a nozzle;
forming a heater disposed on the substrate in a center portion of the ink chamber; and
forming a restrictor having two restricting parts to supply ink from the ink feed hole to the ink chamber, and each restricting part extending through the substrate to the ink feed hole on opposite sides of the heater.

14. The method according to claim 13, wherein the heater comprises a first heater, a second heater, and a slit disposed between the first heater and the second heater.

15. The method according to claim 14, wherein the first heater and the second heater are connected at both ends thereof, and the slit extends along a direction that is parallel to a longitudinal inner wall of the ink chamber.

16. The method according to claim 14, wherein the slit is disposed to face the nozzle so that a cavitation force is applied to the slit.

17. The method according to claim 14, wherein the first heater, the second heater, and the slit are formed on the substrate to face the nozzle through the ink chamber.

18. The method according to claim 14, wherein the first heater and the second heater protrude from the substrate toward the ink chamber, and the slit is defined by sidewalls of the first heater and the second heater.

19. The method according to claim 14, wherein the first heater and the second heater are spaced apart by a width of the slit so that a cavitation force is applied to the slit.

20. The method according to claim 14, wherein the first heater and the second heater are disposed between the two restricting parts.

21. The method according to claim 13, wherein the two restricting parts extend through the substrate adjacent to inner walls of the ink chamber.

22. The method according to claim 13, wherein the heater directly contacts the ink without a passivation layer.

23. The method according to claim 13, further comprising:
forming a heater layer disposed on the substrate including the heater patterned therein; and
forming a wiring layer disposed on the heater layer to provide a pulse current to the heater.

24. The method according to claim 23, further comprising:
forming a passivation layer on the heater layer and the wiring layer; and
patterning the passivation layer to expose the heater and a portion of the wiring layer to form a pad.

25. The method according to claim 24, wherein the passivation layer extends to the top surface of the substrate along inner walls of the ink chamber.

26. The method according to claim 23, wherein the forming of the ink flow structure comprises:
forming a chamber layer by depositing a chamber layer material on the heater layer and the wiring layer and patterning the chamber layer material;
depositing a sacrificial layer on the chamber layer, the heater layer, and the wiring layer;
polishing the sacrificial layer to expose a top surface of the chamber layer;
forming a nozzle layer by depositing a nozzle layer material and patterning the nozzle layer material to define the nozzle; and
removing the sacrificial layer through the ink feed hole.

27. The method according to claim 23, wherein the forming of the heater layer and the wiring layer comprises forming the wiring layer around at least one inner wall of the ink chamber that is perpendicular to a direction in which the restrictor extends and to contact the heater adjacent the at least one inner wall.

28. An inkjet print head with a high efficiency heater, comprising:
an ink-feed hole formed at a bottom surface of a substrate;
a restrictor formed on a top surface of the substrate to be in fluid communication with the ink-feed hole;
a chamber layer formed on the substrate and having an ink chamber and a nozzle to communicate with the ink-feed hole through the restrictor; and
a wiring layer and a heater layer formed between the chamber layer and the substrate,
wherein a portion of the heater layer located in the ink chamber is in direct contact with ink filled in the ink chamber, and has a slit formed at a center of the portion.

29. The inkjet print head according to claim 37, wherein the slit has a width of 1˜3 μm.

30. The inkjet print head according to claim 37, wherein the restrictor extends in a direction perpendicular to the top surface of the substrate and a direction in which the heater layer extends.

31. The inkjet print head according to claim 39, wherein the restrictor is spaced apart from the heater in the ink chamber by a distance of not more than 3 μm.

32. An inkjet print head, comprising:
a substrate having an ink feed hole extending therethrough;
an ink flow structure disposed on the substrate to define an ink chamber and a nozzle;
a heater disposed on the substrate in a center portion of the ink chamber; and
a restrictor having two restricting parts to supply ink from the ink feed hole to the ink chamber, and each restricting part extending through the substrate to the ink feed hole on opposite sides of the heater.

33. The inkjet print head according to claim 32, wherein the heater comprises a first heater, a second heater, and a slit disposed between the first heater and the second heater.

34. The inkjet print head according to claim 33, wherein the first heater and the second heater are connected at both ends thereof, and the slit extends along a direction that is parallel to a longitudinal inner wall of the ink chamber.

35. The inkjet print head according to claim 33, wherein the slit is disposed to face the nozzle so that a cavitation force is applied to the slit.

36. The inkjet print head according to claim 33, wherein the first heater, the second heater, and the slit are formed on the substrate to face the nozzle through the ink chamber.

37. The inkjet print head according to claim 33, wherein the first heater and the second heater protrude from the substrate toward the ink chamber, and the slit is defined by sidewalls of the first heater and the second heater.

38. The inkjet print head according to claim 33, wherein first heater and the second heater are spaced apart by a width of the slit so that a cavitation force is applied to the slit.

39. The inkjet print head according to claim 33, wherein the first heater and the second heater are disposed between the two restricting parts.

40. The inkjet print head according to claim 32, further comprising:
a heater layer disposed on the substrate including the heater patterned therein; and
a wiring layer disposed on the heater layer to provide a pulse current to the heater.

41. The inkjet print head according to claim 32, wherein the heater directly contacts the ink without a passivation layer.
